(19) United States
(12) Patent Application Publication
(10) Pub. No.: US 2018/0051412 A1
(43) Pub. Date: Feb. 22, 2018

(54) SPECIALTY FABRICS HAVING ANTI-MICROBIAL, STAIN RELEASE, AND DUST RESISTANT PROPERTIES

(71) Applicant: Reliance Industries Limited, Mumbai (IN)

(72) Inventor: Sujit Kumar Barik, Ahmedabad (IN)

(73) Assignee: Reliance Industries Limited, Mumbai (IN)

(21) Appl. No.: 15/680,961

(22) Filed: Aug. 18, 2017

(30) Foreign Application Priority Data
Aug. 19, 2016 (IN) 201621028354

(51) Int. Cl. D06M 13/156; C09D 5/14; C09D 7/12; A01N 31/08; D06M 13/144; D06M 15/643; D06M 13/08; D06M 11/78

(52) U.S. Cl. CPC D06M 13/156; C09D 5/14; C09D 7/1216; C09D 7/1233; A01N 31/08; D06M 2101/06; D06M 15/643; D06M 13/08; D06M 11/78; D06M 2200/01; D06M 13/144

(57) ABSTRACT

The present disclosure relates to specialty fabrics. Also disclosed is a coating composition, which is applied on a fabric to obtain the specialty fabric having anti-microbial, stain release and dust resistant properties. The specialty fabric is safe for the human skin, is economical, and can be successfully used in many applications like in nursing homes/hospitals, operation theatres, for preparing sports apparel, and the like.

### FIELD

The present disclosure relates to specialty fabrics.

### Definitions

As used in the present disclosure, the following terms are generally intended to have the meaning as set forth below, except to the extent that the context in which they are used indicate otherwise.

Specialty fabrics: Specialty fabrics are those fabrics that are designed for specialized applications and have a unique composition, weave, or technology.

Greige Fabric: The fabric taken straight from weaving/knitting which has not been subjected to washing or any chemical processing.

Finishing compounds: Finishing compounds are compounds coated over the fibers of a fabric to achieve specific properties in the fabric, for example, heat-setting, hydrophilicity, anti-static behavior, non-slip behavior, fire resistant, anti-microbial behavior and the like.

Scouring: It is a process in which the greige fabric is subjected to washing with the help of synthetic detergents and stain removers in order to remove dirt, dust, stains and various oily substances from the greige fabric and Making it suitable for further chemical and mechanical processing.

Dyeing: It is a process wherein different types of dye stuffs are absorbed into the fabric in order to achieve the desired color.

Singeing: In this process the fabric is made to pass over a series of flames across the entire width to burn out the fibres protruding from the fabric surface. This is done to make the fabric surface smooth & clean.

Crabbing: Crabbing sets the cloth and yarn twist by passing the fabric over cylinders through a hot-water bath, or through a series of progressively hotter baths, followed by a cold-water bath. Crabbing is done to stabilize the fabric before dyeing and finishing and is necessary only for wool fabrics.

Heat Setting: It means a process of conferring stability upon fibres, yarns, or fabrics, by means of hot air.

Shearing: In this process the fabric is passed over a set of rotating helical blades, across the width of the fabric to clean the surface hairs.

Keir decatising: Keir decatising is a finishing treatment whereby a fabric's physical and dimensional form is enhanced and then stabilized by the use of heat, moisture, pressure, and time. Generally, a pressure decatising method produces a permanent change in fabric properties by the action of heat and pressurized steam at greater than 100 kPa (1 atm) pressure on a mechanically constrained fabric, and is usually performed during the final stages of fabric production for several reasons: (a) to develop desirable aesthetic qualities in the fabric such as handle, luster and smoothness, (b) to improve the dimensional stability of the fabric particularly for purposes of garment assembly, (c) to permanently set or preserve these qualities during fabric use.

Pick-up %: It is the quantity of a solution/composition absorbed by the fabric after squeezing, expressed as the percentage to the weight of the dry fabric. Pick-up % is calculated as below:

$$Pick \text{-} up \% = \frac{( \begin{matrix}G S M of the wet fabric after squeezing - \\ G S M of Fabric before application\end{matrix} ) \times 100}{G S M of Fabric before application}$$

GSM—Grams per square meter

Stenter—Stenter is an open width finishing machine where the fabric passes through a set of chambers, with provision of hot air blowing. This machine can he used for drying and heat setting of fabric.

AATCC 1.47: “AATCC 147” (Antibacterial Activity: Parallel Streak Method)” refers to the standard test to detect bacteriostatic activity on textile materials. The method is useful for obtaining a rough estimate of antibacterial activity. In this method the growth of the inoculum organism decreases from one end of each streak to the other and from one streak to the next resulting in increasing degrees of sensitivity. This method comprises following steps:
Specimens of the test materials are placed in intimate contact with the agar surface which has been previously streaked with an inoculum of a test bacterium.
After incubation, a clear area of interrupted growth underneath and along the side of the test material indicates antibacterial activity of the specimen.

Program 7A of ISO 6330: “Program 7A of ISO 6330” refers to an International Standard 6330, which specifies domestic washing and drying procedures for textile testing. The procedures are applicable to textile fabrics, garments or other textile articles which are subjected to appropriate combinations of domestic washing and drying procedures. This International Standard also specifies the reference detergents and ballasts for the procedures.

### BACKGROUND

All fabrics, whether made of natural, synthetic or semi-synthetic material, are prone to microbial growth, staining, and collection of dust and pollens to varying degrees. Infestation by microbes causes development of odor, specially when the fabric is worn next to the skin and may even cause skin infection. It may even be a site for mold growth affecting the quality of the fabric. Humid and warm environment can even aggravate the problem.

Staining, can also affect the color and aesthetics of the fabric. Some stains are permanent and cannot be removed in spite of improved washing techniques. Similarly, dust and pollens that get collected on the surface of the fabric may pose a health threat to the wearer or anyone who comes in contact with the contaminated fabric in the form of allergy or asthma.

Thus, there is felt a need to develop a specialty fabric which is anti-microbial, stain release, and dust resistant.

### Objects

Some of the objects of the present disclosure, which at least one embodiment herein satisfies, are as follows.

It is an object of the present disclosure to ameliorate one or more problems of the prior art or to at least provide a useful alternative.

An object of the present disclosure is to provide a specialty fabric with anti-microbial, stain release and dust resistant properties.

Another object of the present disclosure is to provide a specialty fabric with anti-microbial, stain release, and dust resistant properties that is durable.

Still another object of the present disclosure is to provide a specialty fabric with anti-microbial, stain release, and dust resistant properties which does not alter the tone, color, hand feel and appearance of the fabric.

Yet another object of the present disclosure is to provide a process for the preparation of a specialty fabric which has anti-microbial, stain release, and dust resistant properties.

Other objects and advantages of the present disclosure will be more apparent from the following description, which is not intended to limit the scope of the present disclosure.

### SUMMARY

In accordance with one aspect of the present disclosure, there is provided a coating composition comprising an antimicrobial formulation in an amount in the range of 15 wt % to 30 wt % with respect to the total weight of the composition; nanoparticles in an amount in the range of 10 wt % to 20 wt % with respect to the total weight of the composition, a stain release compound in an amount in the range of 10 wt % to 50 wt % with respect to the total weight of the composition and a dust resistant compound in an amount in the range of 20 wt % to 50 wt % with respect to the total weight of the composition.

In accordance with the embodiments of the present disclosure the coating composition further comprises acetic acid in an amount in the range of 1.5 wt % to 2.5 wt % with respect to the total weight of the composition.

The coating composition, when applied over a fabric renders the fabric with anti-microbial, stain release, dust resistant and anti-pollen properties.

The antimicrobial formulation comprises at least one antimicrobial compound, at least one perfume and at least one alcohol.

In accordance with the embodiments of the present disclosure, the antimicrobial compound is selected from the group consisting of 2-chloro-5-hydroxy-1,3-dimethylbenzene, 2-chloro-5-hydroxy-m-xylene, 4-chloro-3,5-xylenol, 4-chloro-3,5-dimethylphenol, 4-chloro-5,3-dimethylphenol, 4-chloro-m-xylenol, p-chloro-3,5-xylenol, p-chloro-m-xylenol, chlorocresol, chlorophene, hexachlorophene, triclosan, hydroxyquinoline sulphate, potassium hydroxyquinoline sulphate, chlorquinaldol, dequalinium chloride, di-iodohydroxyquinoline, Burow's solution, hydrogen peroxide solution, potassium permanganate solution, benzoyl peroxide, chlorhexidine gluconate, chlorhexidine acetate, benzalkonium chloride, cetrimide, methylbenzethonium chloride, benzethonium chloride, cetalkonium chloride, cetylpyridinium chloride, dofanium chloride, and domiphen bromide.

In accordance with the embodiments of the present disclosure, the perfume is terpineol.

In accordance with the embodiments of the present disclosure, the alcohol is at least one selected from the group consisting of ethyl alcohol and isopropyl alcohol.

In accordance with the embodiments of the present disclosure, the nanoparticles are silicon nanoparticles.

In accordance with the embodiments of the present disclosure, the stain release compound is a fluorocarbon compound.

In accordance with one embodiment of the present disclosure, the stain release compound is C6 fluorocarbon.

In accordance with the embodiments of the present disclosure, the dust resistant compound is at least one selected from the group consisting of polysiloxanes and derivatives thereof.

In accordance with the embodiments of the present disclosure, the dust resistant compound is silicon oil.

In accordance with the embodiments of the present disclosure, the fabric comprises fibres of at least one material selected from the group consisting of wool, cotton, silk, linen, hemp, ramie, jute, rayon, nylon, polyester, aramid, acrylic, spandex, olefin fibre, polyester viscose, polyester wool, modacrylic olefin acrylic polyester, polytetrafluoroethylene, polypropylene, polyphenylene ether, carbon fiber, vinyon, saran, vinalon, modal, sulfas, polybenzimidazole fibre, polylactic acid, lyocell, orlon, vectran, and zylonacrylonitrile.

In accordance with another aspect of the present disclosure, there is provided a process for preparing a specialty fabric. The process comprises providing a fabric selected from woven and knitted fabrics and subjecting said fabric to a pre-treatment to obtain a pre-treated fabric. The coating composition is applied over the pre-treated fabric at a temperature in the range of 25° C. to 50° C. to obtain a treated fabric. The treated fabric is subjected to a post-treatment to obtain said specialty fabric, wherein said specialty fabric has anti-microbial, stain release, and dust resistant properties.

In accordance with the embodiments of the present disclosure, the coating composition is mixed with a predetermined amount of at least one binder and a predetermined amount of at least one finishing compound, prior to applying on the pre-treated fabric.

In accordance with the embodiments of the present disclosure, the pre-treatment comprises at least operation selected from the group consisting of scouring at a temperature in the range of 55° C. to 60° C., drying at a temperature in the range of 90° C. to 160° C., heat setting on a stenter at a temperature in the range of 170° C. to 210° C., dyeing, singeing, crabbing and shearing.

In accordance with the embodiments of the present disclosure, the post-treatment comprises at least one operation selected from the group consisting of drying at a temperature in the range of 90° C. to 160° C., pressing and bier decatising at a temperature in the range of 100° C. to 115° C.

The specialty fabric prepared using the process of the present disclosure has anti-microbial, stain release, dust resistant and anti-pollen properties.

### BRIEF DESCRIPTION OF THE ACCOMPANYING DRAWING

The present disclosure will now be described with the help of the accompanying drawing, in which:

FIG. 1 illustrates a process for preparing a specialty fabric having anti-microbial, stain release, dust resistant and anti-pollen properties.

### DETAILED DESCRIPTION

Fabrics are generally prone to microbial growth, staining, collection of dust and pollens. This affects the quality of the fabric or poses a health threat to persons coming in contact with the fabric in the form of allergy or asthma. The present disclosure, therefore, envisages specialty fabrics that have anti-microbial, stain release, dust resistant and anti-pollen properties, and a process for preparation of such specialty fabrics.

In accordance with one aspect of the present disclosure, there is provided a coating composition, which on applying over a fabric renders the fabric with anti-microbial, stain release, dust resistant and anti-pollen properties.

The coating composition of the present disclosure comprises:
a) an antimicrobial formulation in an amount in the range of 15 wt % to 30 wt % with respect to the total weight of said composition;
b) nanoparticles in an amount in the range of 10 wt % to 20 wt % with respect to the total weight of said composition;
c) a stain release compound in an amount in the range of 10 wt % to 50 wt % with respect to the total weight of said composition; and
d) a dust resistant compound in an amount in the range of 20 wt % to 50 wt % with respect to the total weight of said composition.

In accordance with the embodiments of the present disclosure the coating composition further comprises acetic acid in an amount in the range of 1.5 wt % to 2.5 wt % with respect to the total weight of the composition.

In accordance with the embodiments of the present disclosure, the antimicrobial formulation comprises at least one antimicrobial compound, at least one perfume and at least one alcohol.

The antimicrobial compound is selected from the group consisting of 2-chloro-5-hydroxy-1,3-dimethylbenzene, 2-chloro-5-hydroxy-m-xylene, 4-chloro-3,5-xylenol, 4-chloro-3,5-dimethylphenol, 4-chloro-5,3-dimethylphenol, 4-chloro-m-xylenol, p-chloro-3,5-xylenol, p-chloro-m-xylenol, chlorocresol, chlorophene, hexachlorophene, triclosan, hydroxyquinoline sulphate, potassium hydroxyquinoline sulphate, chlorquinaldol, dequalinium chloride, di-iodohydroxyquinoline, Burow's solution, hydrogen peroxide solution, potassium permanganate solution, benzoyl peroxide, chlorhexidine gluconate, chlorhexidine acetate, benzalkonium chloride, cetrimide, methylbenzethonium chloride, benzethonium chloride, cetalkonium chloride, cetylpyridinium chloride, dofanium chloride and domiphen bromide. The antimicrobial compound is present in an amount in the range of 0.5 wt % to 1.5 wt % of the total weight of the antimicrobial formulation.

In accordance with the embodiments of the present disclosure, the perfume is terpineol. The perfume is present in an amount in the range of 2 wt % to 8 wt % of the total weight of the antimicrobial formulation.

In accordance with the embodiments of the present disclosure, the alcohol is at least one selected from the group consisting of ethyl alcohol and isopropyl alcohol. The alcohol is present in an amount in the range of 95 wt % to 99 wt % of the total weight of the antimicrobial formulation.

In accordance with the embodiments of the present disclosure, the nanoparticles are silicon nanoparticles.

In accordance with the embodiments of the present disclosure, the stain release compounds are selected from the group consisting of fluorocarbon compounds.

In accordance with one embodiment of the present disclosure, the stain release compound is C6 fluorocarbon.

In accordance with the embodiments of the present disclosure, the dust resistant compound is at least one selected from the group consisting of polysiloxanes and derivatives thereof.

In accordance with the embodiments of the present disclosure, the dust resistant compound is silicon oil.

In accordance with the embodiments of the present disclosure, the fabric comprises fibres of at least one material selected from the group consisting of wool, cotton, silk, linen, hemp, ramie, jute, rayon, nylon, polyester, aramid, acrylic, spandex, olefin fibre, polyester viscose, polyester wool, modacrylic olefin acrylic polyester, polytetrafluoroethylene, polypropylene, polyphenylene ether, carbon fiber, vinyon, saran, vinalon, modal, sulfar, polybenzimidazole fibre, polylactic acid, lyocell, orlon, vectran, and zylonacrylonitrile.

The fabric can be one of a woven and a knitted fabric.

The specialty fabric of the present disclosure does not attract microbial growth, staining, and is dust resistant and pollen resistant. Some stains on the specialty fabrics of the present disclosure can be simply removed by a mechanical jerk. Other stubborn stains like coffee, tea and tomato ketchup stains can be easily removed by a simple wash leading to saving of soap and detergent requirement. The specialty fabric of the present disclosure is also safe on human skin.

In accordance with another aspect of the present disclosure, there is provided a process for preparing a specialty fabric having anti-microbial, stain release, dust resistant and anti-pollen properties.

A fabric can be selected from woven and knitted fabrics. The fabric can comprise fibres of at least one material selected from the group consisting of wool, cotton, silk, linen, hemp, ramie, jute, rayon, nylon, polyester, aramid, acrylic, spandex, olefin fibre, polyester viscose, polyester wool, modacrylic olefin acrylic polyester, polytetrafluoroethylene, polypropylene, polyphenylene ether, carbon fiber, vinyon, saran, vinalon, modal, sulfar, polybenzimidazole fibre, polylactic acid, lyocell, orlon, vectran, and zylonacrylonitrile.

The fabric is then subjected to a pre-treatment to obtain a pre-treated fabric. The pre-treatment comprises at least operation selected from the group consisting of scouring, drying, heat setting on a stenter, dyeing, singeing, crabbing and shearing.

Scouring can be carried out at a temperature in the range of 55° C. to 60° C.

Drying can be carried out at a temperature in the range of 90° C to 160° C.

Heat setting on a stenter can be carried out at a temperature in the range of 170° C. to 210° C.

The coating composition for rendering the fabric with anti-microbial, stain release, and dust resistant properties is prepared. The coating composition comprises predetermined weights of an antimicrobial formulation, nanoparticles, a stain release compound, and a dust resistant compound.

The coating composition can further comprise acetic acid in an amount in the range of 1.5 wt % to 2.5 wt %.

Acetic acid facilitates proper mixing of the components of the coating composition.

This composition is then applied over the pre-treated fabric at a temperature in the range of 25° C. to 50° C. to obtain a treated fabric. The treated fabric is then subjected to a post-treatment to obtain the specialty fabric having anti-microbial, stain release, and dust resistant properties.

In accordance with the embodiments of the present disclosure, the coating composition is mixed with a predetermined amount of at least one binder and a predetermined amount of at least one finishing compound, prior to applying on the pre-treated fabric.

In an embodiment, the post-treatment comprises at least one operation selected from the group consisting of drying at a temperature in the range of 90° C. to 160° C., pressing and kier decatising at a temperature in the range of 101° C. to 115° C.

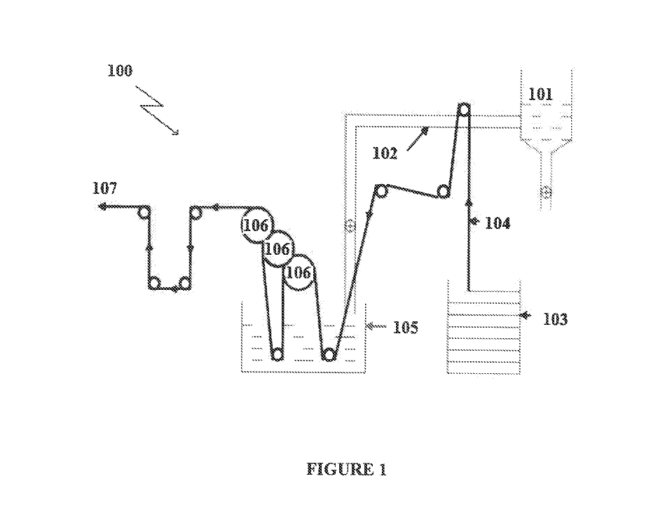

In accordance with one embodiment of the present disclosure, the process assembly for applying the coating composition on the pre-treated fabric is further described with the help of FIG. 1. Typically, the process assembly (100) comprises: a finishing tank (101), a pipe (102) connecting the finishing tank and a mangle (105), a fabric trolley (103), squeeze rollers (106) and a stenter (107) (not shown in the figure), is used.

Initially, the coating composition of the present disclosure and at least one binder are added in the finishing tank (101) along with the desired finishing compounds to obtain a mixture. The mixture goes to the mangle (105) through the pipe (102) for padding where pre-treated fabric (104) picks up the mixture. The fabric then passes through a set of squeezing rollers (106) to squeeze out the excess mixture to result in a wet treated fabric which is then passed over to the stenter (107) not shown in FIG. 1.

In accordance with the embodiments of the present disclosure, the binder is an acrylic copolymer.

In accordance with the embodiments of the present disclosure, the finishing compound is micro-amino silicon softener.

In an embodiment, the pickup of the mixture by the pre-treated fabric is in the range of 55% to 75%. After application of the coating composition, the wet treated fabric enters into a heating chamber of the stenter for drying the wet treated fabric to obtain a dried treated fabric. The dried treated fabric is then subjected to post-treatment (not shown in FIG. 1) to obtain the specialty fabric.

The anti-microbial, property of the specialty fabric prepared by the process of the present disclosure can last for at least 100 washing cycles, as tested by test protocol AATCC-147. The stain release and dust resistant properties of the specialty fabrics prepared by the process of the present disclosure can last for at least 50 washing cycles, as tested by test protocol AATCC-130 In-house method.

The present disclosure is further described in the light of the following laboratory experiments, which are set forth for illustration purpose only, and not to be construed for limiting the scope of the disclosure. The following experiments can be scaled up to industrial/commercial scale, and the results obtained can be extrapolated to industrial scale.

Experiments

Experiment 1a: Preparation of Coating Compositions and Specialty Fabrics

Different coating compositions were formulated and applied on fabrics, to render the fabrics with anti-microbial, stain release, dust resistant and anti-pollen properties.

Six fabrics were taken viz. Polyester/Cellulosic—Suiting/Shirting Fabric (A), 100% Polyester & Polyester/Cellulosic—Piece Dyed Suiting/Shirting Fabric (B), Polyester Wool (C), 100% Wool—Suiting Fabric (D), 100% Polyester Auto textiles—Piece Dyed Fabric (E), and 100% Polyester Auto textiles—Yarn Dyed Fabric (F). The fabrics were subjected to pre-treatinent and predetermined amounts of compositions were applied on pre-treated fabrics. After applying the coating compositions over fabrics, the fabrics were subjected to post-treatment. The details of the coating compositions used for preparing the specialty fabrics are summarized in Table 1.

TABLE 1
Formulation details of the coating composition

| | |
|---|---|
| Coating | Fabric |

| Composition | A | B | C | D | E | F |
|---|---|---|---|---|---|---|
| Acetic acid (gpl) | 2 | 2 | 2 | 2 | 2 | 2 |
| Polysiloxane | 40 | 40 | 30 | 35 | 20 | 15 |
| derivative (silicon | | | | | | |
| oil) (gpl) | | | | | | |
| silicon | 10 | 10 | 15 | 20 | 10 | 15 |
| nanoparticles | | | | | | |
| (gpl) | | | | | | |
| Fluorocarbon | 15 | 15 | 20 | 25 | 30 | 30 |
| compound (C6 | | | | | | |
| Fluorocarbons) | | | | | | |
| (gpl) | | | | | | |
| Antimicrobial | 15 | 15 | 20 | 20 | 20 | 25 |
| formulation (gpl) | | | | | | |

• gpl = grams per litre

The constituents of the antimicrobial formulation were

| | | |
|---|---|---|
| Isopropyl alcohol | 985 | ml |
| Chloroxylenol | 10 | g |
| Perfume (terpineol) | 5 | ml |

The details of the pre-treatment, treatment with the composition and post-treatment along with the process conditions are provided in Table 2.

The greige fabrics were subjected to a pre-treatment in the order: Scouring, drying, heat setting (for Polyester and Polyester blends fabrics) or crabbing (for 100% wool fabrics), singeing, scouring, drying, and optionally, shearing.

After application of compositions, the fabrics were subjected to post-treatment which includes drying, curing, first pressing (optional), keir decatising, and final pressing (using Deco fast machine) to obtain the specialty fabrics.

TABLE 2
Process conditions for the pre-treatment and post treatment of fabrics

| | | | | | | | |
|---|---|---|---|---|---|---|---|
| Sr. | | | | | | | |
| No | Process | (A) | (B) | (C) | (D) | (E) | (F) |

Pre-treatment

| | | | | | | | |
|---|---|---|---|---|---|---|---|
| 1 | Scouring | 55-60° C. | 55-60° C. | 55-60° C. | 55-60° C. | 55-60° C. | 55-60° C. |
| 2 | Drying | 90-160° C. | 90-160° C. | 90-160° C. | 90-160° C. | 90-160° C. | 90-160° C. |
| 3.1 | Heat | 170-210° C. | 170-210° C. | 170-210° C. | ---- | 170-210° C. | 170-210° C. |
| | setting on | | | | | | |
| | Stenter | | | | | | |
| 3.2 | Crabbing | --- | --- | --- | 110- [symbol] ° C. | --- | --- |
| 4 | Dyeing | --- | Max | --- | ----- | Max upto | ----- |
| | | | upto | | | 135° C. | |
| | | | 135° C. | | | | |
| 5 | Drying | ---- | 90-160° C. | ---- | ----- | 90-160° C. | ----- |
| 6 | Singeing | 80-120 Mtr/min | 80-120 Mtr/min | 89-120 Mtr/min | 80-120 Mtr/min | ---- | ----- |
| 7 | Scouring | 55-60° C. | 55-60° C. | 55-60° C. | 55-60° C. | ----- | ----- |
| 8 | Drying | 90-160° C. | 90-160° C. | 90-160° C. | 90-160° C. | ----- | ----- |
| 9 | Shearing | ---- | ---- | 15-30 mtr/min | 15-30 mtr/min | ----- | ----- |

Post-treatment

| | | | | | | | |
|---|---|---|---|---|---|---|---|
| 10 | Drying | 90-150° C. | 90-150° C. | 90-150° C. | 90-150° C. | 90-150° C. | 90-150° C. |
| 11 | Curing | 170-180° C. | 170-180° C. | 170-180° C. | 170-180° C. | 170-180° C. | 170-180° C. |
| 12 | 1^{st} | 15-30 mtr/min | 15-30 mtr/min | 15-30 mtr/min | 15-30 mtr/min | ----- | ----- |
| | pressing | | | | | | |
| 13 | Kier | 100-115° C. | 100-115° C. | 100-115° C. | 100-115° C. | ----- | ----- |
| | Decatising | Pressure | Pressure | Pressure | Pressure | | |
| | | 0.4-1.2 Bar | 0.4-1.2 Bar | 0.4-1.2 Bar | 0.4-1.2 Bar | | |
| 14 | Final | 15-30 mtr/min | 15-30 mtr/min | 15-30 mtr/min | 15-30 mtr/min | ----- | ----- |
| | Pressing | | | | | | |

[symbol]

indicates data missing or illegible when filed

All the six specialty fabrics were tested for the anti-microbial, dust resistant and stain release properties.

Experiment 1b: Assessment of Antimicrobial Activity (AATCC 147-2011)

The antimicrobial activity of the specialty fabrics obtained in experiment 1a were assessed using the Test Standard: AATCC 147-2011 method. The tests were performed for specialty fabrics without a wash and after 100 washings. The washing procedure was standard 7 A of ISO 6330. Staphylococcus aureus, ATCC 6538 and Klebsiella pneumoniae, ATCC 4352 was used as the test culture. The test was carried out for the specialty fabrics A, B, C, E, and F. The untreated fabric was used as the control sample.

Agar was taken in six different petri dishes and was inoculated with Staphylococcus aureus, ATCC 6538 and Klebsiella pneumoniae, ATCC 4352.

The specialty fabrics obtained in Experiment set 1 were placed on individual Petri dish. The area underneath and on the side was examined for bacteria growth. The results obtained are summarized in Table 3.

TABLE 3
Result of the assessment of antimicrobial activity
(AATCC 147) on specialty fabrics

| | | | | Growth | | |
|---|---|---|---|---|---|---|
| Wash | | | Zone of | Under | | |
| Condition | Fabric | Test Organism | Inhibition | Specimen | Conclusion | Test Status |
| Original | A | Staph. Aureus | No Zone | No Growth | Antibacterial | Pass |
| (without | | K. Pneumoniae | No Zone | No Growth | | |
| wash) | B | Staph. Aureus | No Zone | No Growth | Antibacterial | Pass |
| | | K. Pneumoniae | No Zone | No Growth | | |
| | C | Staph. Aureus | No Zone | No Growth | Antibacterial | Pass |
| | | K. Pneumoniae | No Zone | No Growth | | |
| | D | Staph. Aureus | No Zone | No Growth | Antibacterial | Pass |
| | | K. Pneumoniae | No Zone | No Growth | | |
| | E | Staph. Aureus | No Zone | No Growth | Antibacterial | Pass |
| | | K. Pneumoniae | No Zone | No Growth | | |
| | F | Staph. Aureus | No Zone | No Growth | Antibacterial | Pass |
| | | K. Pneumoniae | No Zone | No Growth | | |
| | Control | Staph. Aureus | No zone | Growth | No | Fails |
| | sample | | | | antibacterial | |
| | | | | | activity | |
| After 100 | | K. Pneumoniae | No zone | Growth | | |
| Washes | A | Staph. Aureus | No Zone | No Growth | Antibacterial | Pass |
| | | K. Pneumoniae | No Zone | No Growth | | |
| | B | Staph. Aureus | No Zone | No Growth | Antibacterial | Pass |
| | | K. Pneumoniae | No Zone | No Growth | | |
| | C | Staph. Aureus | No Zone | No Growth | Antibacterial | Pass |
| | | K. Pneumoniae | No Zone | No Growth | | |
| | D | Staph. Aureus | No Zone | No Growth | Antibacterial | Pass |
| | | K. Pneumoniae | No Zone | No Growth | | |
| | E | Staph. Aureus | No Zone | No Growth | Antibacterial | Pass |
| | | K. Pneumoniae | No Zone | No Growth | | |
| | F | Staph. Aureus | No Zone | No Growth | Antibacterial | Pass |
| | | K. Pneumoniae | No Zone | No Growth | | |
| | Control | Staph. Aureus | No zone | Growth | No | Fails |
| | sample | K. Pneumoniae | No zone | Growth | antibacterial | |
| | | | | | activity | |

The specialty fabrics prepared in Experiment set 1 exhibit antibacterial activity against Staphylococcus aureus, ATCC 6538 and Klebsiella pneumoniae, ATCC 4352, when tested according to AATCC 147-2011 method; whereas the untreated fabric control sample does not exhibit antimicrobial activity.

From the results it is clear that all the specialty fabrics of experiment 1a (A-F), possess antimicrobial property at initial condition (without wash) and after 100 washings. The specialty fabrics prepared in accordance with the present disclosure passes the test, when tested according to AATCC 147-2011 method.

Experiment 1c: Assessment of Stain Release Properties of Specialty Fabrics: Test Method AATCC 130

The specialty fabrics obtained in experiment set 1 were tested for stain release properties using AATCC 130 method. In this method, the specialty fabrics samples were exposed to corn oil and then laundered. Stains other than corn oil were also used. The specialty fabric samples after washing were then compared to photographic standards and rated. No pre-treater or additional stain remover used during testing. The test was performed for specialty fabrics without wash and after 50 washings. The washing procedure was in accordance with standard 7 A of ISO 6330 The results are summarized in Table 4.

TABLE 4
Result of assessment of stain release properties of specialty fabrics
(AATCC 130)

| Wash | | | | |
|---|---|---|---|---|
| Condition | Fabric | Stain with | Rating | Test Status |
| Original | A | Soya Sauce/Corn | 4/3.5/4/4/3.5 | Pass |
| | | Oil/Tea/Coffee/Tomato ketchup | | |
| Original | B | Soya Sauce/Corn | 4/3.5/4/4/3.5 | Pass |
| | | Oil/Tea/Coffee/Tomato ketchup | | |
| Original | C | Soya Sauce/Corn | 4/3.5/4/4/3.5 | Pass |
| | | Oil/Tea/Coffee/Tomato ketchup | | |
| Original | D | Soya Sauce/Corn | 4/3.5/4/4/3.5 | Pass |
| | | Oil/Tea/Coffee/Tomato ketchup | | |
| Original | E | Soya Sauce/Corn | 4/3.5/4/4/3.5 | Pass |
| | | Oil/Tea/Coffee/Tomato ketchup | | |
| Original | F | Soya Sauce/Corn | 4/3.5/4/4/3.5 | Pass |
| | | Oil/Tea/Coffee/Tomato ketchup | | |
| After 50 | A | Soya Sauce/Corn | 4/3.5/4/4/3.5 | Pass |
| Washes | | Oil/Tea/Coffee/Tomato ketchup | | |
| After 50 | B | Soya Sauce/Corn | 4/3.5/4/4/3.5 | Pass |
| Washes | | Oil/Tea/Coffee/Tomato ketchup | | |
| After 50 | C | Soya Sauce/Corn | 4/3.5/4/4/3.5 | Pass |
| Washes | | Oil/Tea/Coffee/Tomato ketchup | | |
| After 50 | D | Soya Sauce/Corn | 4/3.5/4/4/3.5 | Pass |
| Washes | | Oil/Tea/Coffee/Tomato ketchup | | |
| After 50 | E | Soya Sauce/Corn | 4/3.5/4/4/3.5 | Pass |
| Washes | | Oil/Tea/Coffee/Tomato ketchup | | |
| After 50 | F | Soya Sauce/Corn | 4/3.5/4/4/3.5 | Pass |
| Washes | | Oil/Tea/Coffee/Tomato ketchup | | |

From Table 4, it is observed that specialty fabrics prepared in experiment set 1a passed the test for the stain release property.

Thus, it can be established that specialty fabrics having the coating composition of the present disclosure exhibit stain release properties, even after 50 washings.

Experiment 1d: Assessment of Dust Resistant Properties of Specialty Fabrics

The specialty fabrics obtained in experiment 1a were tested by an In-house test method of dust resistant property. In this method the sample of the specialty fabrics, A, B, C, D, E and F were cut into the size of 6 cm×12 cm. 250 g fine grade dust was taken in the large poly-bag. All the specialty fabrics were immersed in the dust-filled poly-bag and the mouth of poly-bag was closed. The hag was thoroughly rotated so that fabrics are covered in the dust. The fabric samples were taken out and were jerked 5 times in air to remove lightly bound dust by force. The specialty fabric samples were then put under a light source for rating against a grey scale. The grading is given in Table 5.

TABLE 5
Results for dust resistant properties of specialty fabrics

| Wash Condition | Formulation | Rating | Test Status |
|---|---|---|---|
| Original | A | 4.0 | Pass |
| Original | B | 4.0 | Pass |
| Original | C | 4.0 | Pass |
| Original | D | 3.5 | Pass |
| Original | E | 3.5 | Pass |
| Original | F | 3.5 | Pass |
| After 50 Washes | A | 4.0 | Pass |
| After 50 Washes | B | 4.0 | Pass |
| After 50 Washes | C | 4.0 | Pass |
| After 50 Washes | D | 3.5 | Pass |
| After 50 Washes | E | 3.5 | Pass |
| After 50 Washes | F | 3.5 | Pass |

The visual assessment was as follows:

| Grade | Description |
|---|---|
| 5 | No Dust/change in shade |
| 4 | Slightly dusty/with a little change in shade |
| 3 | Moderate Dusty with partially covering specimen surface and |
| | change in shade |
| 2 | Dusty fabric with a large area with dustiness/remarkable |
| | change in shade |
| 1 | Highly Dusty fabric/complete change in shade. |

From Table 5, it is observed that specialty fabrics having the coating composition of the present disclosure exhibited a good dust resistant property.

Similar results were obtained when the specialty fabrics were exposed to pollen grains, thereby showing anti-pollen properties.

The specialty fabrics obtained in experiment set 1 were washed 100 times for testing the antimicrobial property, 50 times for testing the stain release property, and 50 times for testing dust resistant property. After all the washings, the coating composition was found to be intact on the fabric and there was no depletion of the coating composition. Thus, it was established that the coating composition is durable for at least 100 washings.

Thus, the specialty fabrics with the coating composition of the present disclosure exhibit antimicrobial, stain release, and dust resistant properties.

### Technical Advances and Economical Significance

The present disclosure described herein above has several technical advantages including, but not limited to, the realization of specialty fabrics having anti-microbial, stain release, and dust resistant properties, that:
are durable for at least 100 washings;
do not alter the tone, color, hand-feel, and appearance of the fabric post-treatment;
save soap and detergent as the fabric does not attract stains; and
are inexpensive.

The foregoing description of the specific embodiments so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

We claim:

1. A coating composition comprising
a) an antimicrobial formulation in an amount in the range of 15 wt % to 30 wt % with respect to the total weight of said composition;
b) nanoparticles in an amount in the range of 10 wt % to 20 wt % with respect to the total weight of said composition;
c) a stain release compound in an amount in the range of 10 wt % to 50 wt % with respect to the total weight of said composition; and
d) a dust resistant compound in an amount in the range of 20 wt % tie 50 wt % with respect to the total weight of said composition,
wherein said composition is applied over a fabric to obtain a specialty fabric having anti-microbial, stain release, and dust resistant properties.

2. The composition as claimed in claim 1, wherein said coating composition comprises acetic acid in an amount in the range of 1.5 wt % to 2.5 wt % with respect to the total weight of said composition.

3. The composition as claimed in claim 1, wherein said antimicrobial formulation comprises at least one antimicrobial compound, at least one perfume and at least one alcohol.

4. The composition as claimed in claim 3, wherein said antimicrobial compound is selected from the group consisting of 2-chloro-5-hydroxy-1,3-dimethylbenzene, 2-chloro-5-hydroxy-m-xylene, 4-chloro-3,5-xylenol, 4-chloro-3,5-dimethylphenol, 4-chloro-5,3-dimethylphenol, 4-chloro-m-xylenol, p-chloro-3,5-xylenol, p-chloro-m-xylenol, chlorocresol, chlorophene, hexachlorophene, triclosan, hydroxyquinoline sulphate, potassium hydroxyquinoline sulphate, chlorquinaldol, dequalinium chloride, di-iodohydroxyquinoline, Burow's solution, hydrogen peroxide solution, potassium permanganate solution, benzoyl peroxide, chlorhexidine gluconate, chlorhexidine acetate, benzalkonium chloride, cetrimide, methylbenzethonium chloride, benzethonium chloride, cetalkonium chloride, cetylpyridinium chloride, dofanium chloride, and domiphen bromide.

5. The composition as claimed in claim 3, wherein said perfume is terpineol.

6. The composition as claimed in claim 3, wherein said alcohol is at least one selected from the group consisting of ethyl alcohol and isopropyl alcohol.

7. The composition as claimed in claim 1, wherein said nanoparticles are silicon nanoparticles.

8. The composition as claimed in claim 1, wherein said stain release compound is a fluorocarbon compound.

9. The composition as claimed in claim 1, wherein said stain release compound is C6 fluorocarbon.

10. The composition as claimed in claim 1, wherein said dust resistant compound is at least one selected from the group consisting of polysiloxanes and derivatives thereof.

11. The composition as claimed in claim 1, wherein said dust resistant compound is silicon oil.

12. The composition as claimed in claim 1, wherein said fabric comprises fibres of at least one material selected from the group consisting of wool, cotton, silk, linen, hemp, ramie, jute, rayon, nylon, polyester, aramid, acrylic, spandex, olefin fibre, polyester viscose, polyester wool, modacrylic olefin acrylic polyester, polytetrafluoroethylene, polypropylene, polyphenylene ether, carbon fiber, vinyon, saran, vinalon, modal, sulfar, polybenzimidazole fibre, polylactic acid, lyocell, orlon, vectran, and zylonacrylonitrile.

13. A process for preparing a specialty fabric; said process comprising the following steps:
a) providing a fabric selected from woven and knitted fabrics;
b) subjecting said fabric to a pre-treatment to obtain a pre-treated fabric;
c) providing a coating composition comprising an antimicrobial formulation in an amount in the range of 15 wt % to 30 wt % with respect to the total weight of said composition; nanoparticles in an amount in the range of 10 wt % to 20 wt % with respect to the total weight of said composition; a stain release compound in an amount in the range of 10 wt % to 50 wt % with respect to the total weight of said composition; and a dust resistant compound in an amount in the range of 20 wt % to 50 wt % with respect to the total weight of said composition;
d) applying said coating composition over said pre-treated fabric at a temperature in the range of 25° C. to 50° C. to obtain a treated fabric; and
e) subjecting said treated fabric to a post-treatment to obtain said specialty fabric, wherein said specialty fabric has anti-microbial, stain release, and dust resistant properties.

14. The process as claimed in claim 13, wherein said coating composition comprises acetic acid in an amount in the range of 1.5 wt % to 2.5 wt % with respect to the total weight of said composition.

15. The process as claimed in claim 13, wherein in step (d) said coating composition is mixed with a predetermined amount of at least one binder and a predetermined amount of at least one finishing compound, prior to applying over said pre-treated fabric.

16. The process as claimed in claim 15, wherein said binder is acrylic copolymer.

17. The process as claimed in claim 15, wherein said finishing compound is micro-amino silicon softener.

18. The process as claimed in claim 13, wherein in step (b) said pre-treatment comprises at least operation selected from the group consisting of scouring at a temperature in the range of 55° C. to 60° C., drying at a temperature in the range of 90° C. to 160° C., heat setting on a stenter at a temperature in the range of 170° C. to 210° C., dyeing, singeing, crabbing and shearing.

19. The process as claimed in claim 13, wherein in step (e) said post-treatment comprises at least one operation selected from the group consisting of drying at a temperature in the range of 90° C. to 160° C., pressing and kier decatising at a temperature in the range of 100° C. to 115° C.

20. A specialty fabric having anti-microbial, stain release, and dust resistant properties prepared by the process as claimed in claim 13.
